(19) United States
(12) Patent Application Publication
(10) Pub. No.: US 2019/0084063 A1
(43) Pub. Date: Mar. 21, 2019

(54) TOOL FOR PROCESSING ENGINE BLOCK AND METHOD OF PROCESSING ENGINE BLOCK

(71) Applicant: KORLOY INC, Seoul (KR)

(72) Inventors: Sun Kyoo LEE, Chungcheongbuk-do (KR); Dong Ryong JI, Chungcheongbuk-do (KR); Taeg Won LEE, Chungcheongbuk-do (KR); Byung Sun CHOI, Chungcheongbuk-do (KR)

(73) Assignee: KORLOY INC, Seoul (KR)

(21) Appl. No.: 16/130,054

(22) Filed: Sep. 13, 2018

(30) Foreign Application Priority Data
Sep. 15, 2017 (KR) 10-2017-0118509

(51) Int. Cl. B23F 21/23; B23C 5/06; B23F 21/12; B23F 21/14

(52) U.S. Cl. CPC B23F 21/23; B23C 5/06; B23C 3/00; B23F 21/14; B23F 21/122

(57) ABSTRACT

Disclosed is a tool for processing an engine block. The tool for processing the engine block includes: multiple cutting inserts; and main cutting edges which are formed at end portions of the inserts, respectively, in which the main cutting edge has a positive axial inclination angle and a radial inclination angle of −5 degrees to 0 degree.

### CROSS-REFERENCE TO RELATED APPLICATIONS

This application claims benefit and priority to Korean Patent Application No. 10-2017-0118509, filed on Sep. 15, 2017, with the Korean Intellectual Property Office, the disclosure of which is incorporated herein in its entirety by reference.

### TECHNICAL FIELD

The present disclosure relates to a tool and a method for processing an engine block, and more particularly, to a tool and a method for processing an engine block which are provided to simultaneously process an engine block made of different materials including aluminum and cast iron.

### BACKGROUND

In general, an engine of a vehicle is configured as an assembly including a cylinder block, a cylinder head, a cylinder head cover, and the like.

Based on types of materials, the cylinder blocks are broadly classified into a cast iron mono-block which is entirely manufactured only by using cast iron, and a different-material cylinder block which is manufactured by inserting a cast iron liner into an aluminum body.

As methods of processing the different-material cylinder block, there are a method of processing only an upper surface of aluminum, and a method of simultaneously processing the aluminum body and the cast iron liner.

In the related art, because a solution related to the method of simultaneously processing the aluminum body and the cast iron liner is not provided, the method of only processing the upper surface of the aluminum is adopted. However, recently, the use of the method of simultaneously processing the aluminum body and the cast iron liner is increased as a need for an improvement on engine output is increased.

However, because the aluminum body and the cast iron liner are made of different materials, there are problems in that burrs are formed when the aluminum body and the cast iron liner are simultaneously processed, and a tool life is shortened.

To solve the aforementioned problems, in the related art, a process of chamfering in advance an edge portion of a material having high hardness or brittleness is performed as a pre-processing process and then the simultaneous processing is performed, or a post-processing process for removing burrs is required even though the pre-processing process is not required. As a result, there are problems in that manufacturing costs are increased and a manufacturing speed is decreased.

In the case of the related art (Korean Patent Application Laid-Open No. 2003-0045860) for simultaneously processing the block made of different materials, the processing is performed at a cutting speed of 1,000 m/min or higher, and as a result, there are problems in that roughness deteriorates, and an actual lifespan of a tool is also shortened to 100 ea/corner, such that productivity deteriorates and manufacturing costs are increased because the tool needs to be frequently replaced.

### SUMMARY

The present disclosure has been made in an effort to solve the aforementioned problems in the related art, and an object of the present disclosure is to provide a tool and a method for processing an engine block which may increase a tool life while satisfying roughness when simultaneously processing the engine block made of different materials.

An exemplary embodiment of the present disclosure provides a tool for simultaneously processing an engine block made of different materials, the tool including: multiple cutting inserts; and main cutting edges which are formed at end portions of the inserts, respectively, in which the main cutting edge has a positive axial inclination angle and a radial inclination angle of −5 degrees to 0 degree.

The tool may process the engine block made of different materials with a cutting speed of 400 to 800 m/min and a feed per tooth of 0.05 to 0.099 mm/tooth.

The tool may process the engine block made of different materials with a spindle rotational speed of 637 to 764 rpm.

The tool may process the engine block made of different materials with a cutting speed of 500 to 600 m/min and a feed per tooth of 0.062 to 0.087 m/tooth.

Another exemplary embodiment of the present disclosure provides a method of processing an engine block made of different materials by using a tool including a cutting insert, in which the tool processes the engine block made of different materials with a cutting speed of 400 to 800 m/min, a feed per tooth of 0.05 to 0.099 mm/tooth, and a spindle rotational speed of 637 to 764 rpm.

According to the present disclosure, by controlling the cutting speed, the feed per tooth, the spindle rotational speed, and the radial inclination angle of the main cutting edge when processing the engine block made of different materials, the tool life of the tool for processing the engine block is innovatively increased, such that production costs are reduced, and productivity of the engine block is innovatively increased.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a perspective view illustrating a tool for processing an engine block according to the present disclosure.

FIG. 2 is a schematic view briefly illustrating an axial inclination angle and a radial inclination angle of a main cutting edge according to the present disclosure.

FIG. 3A is a view illustrating a tool life with respect to a cutting speed according to the present disclosure.

FIG. 3B is a view illustrating surface roughness with respect to a feed per tooth according to the present disclosure.

FIG. 3C is a view illustrating a tool life with respect to a radial inclination angle of an insert according to the present disclosure.

FIG. 4 is a view illustrating an engine block which is processed by the tool for processing an engine block according to the present disclosure.

### DETAILED DESCRIPTION

In the following detailed description, reference is made to the accompanying drawing, which forms a part hereof. The illustrative embodiments described in the detailed description, drawing, and claims are not meant to be limiting. Other embodiments may be utilized, and other changes may be made, without departing from the spirit or scope of the subject matter presented here.

Hereinafter, exemplary embodiments of the present disclosure will be described in detail with reference to the accompanying drawings so that those skilled in the art to which the present disclosure pertains may easily carry out the exemplary embodiments. However, the present disclosure may be implemented in various different ways, and is not limited to exemplary embodiments described herein. A part irrelevant to the description will be omitted in the drawings in order to clearly describe the present disclosure, and similar constituent elements will be designated by similar reference numerals throughout the specification.

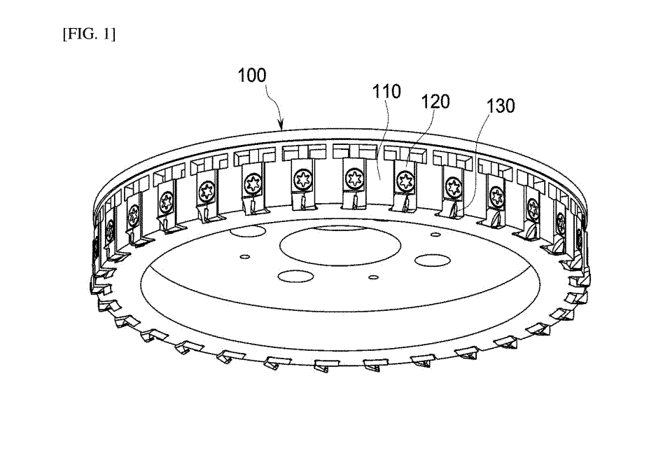

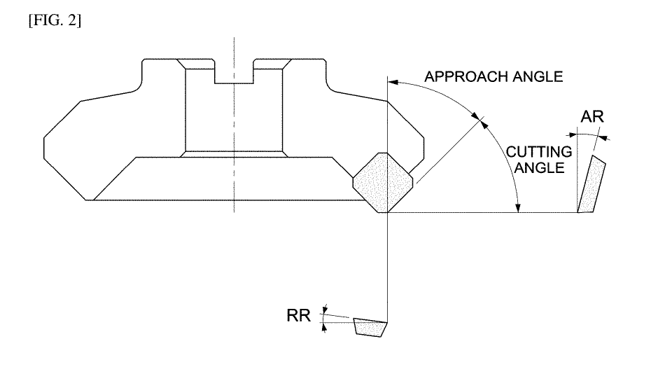

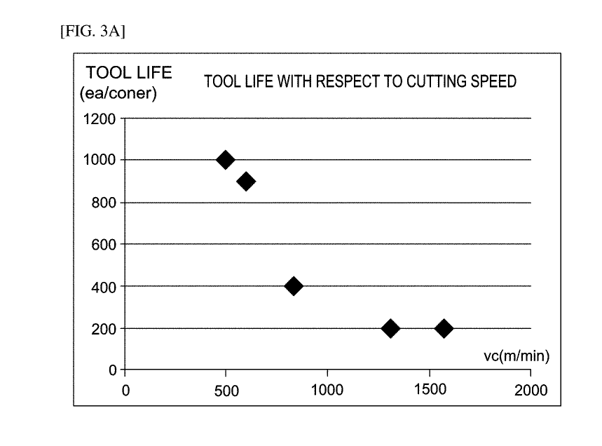

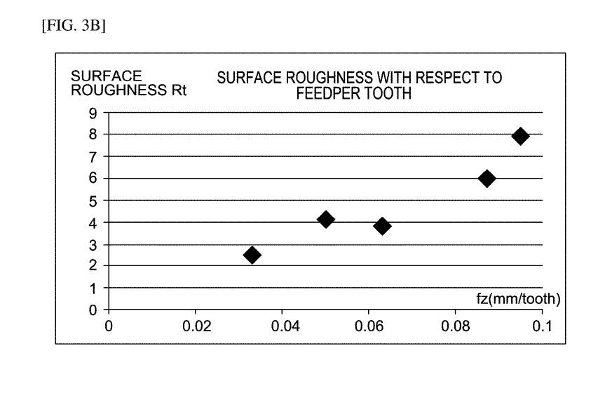

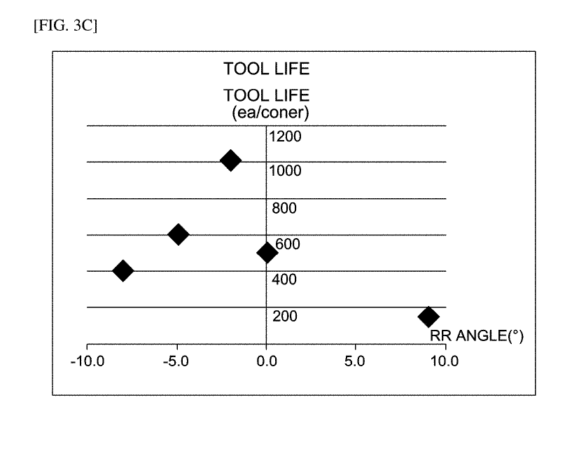

FIG. 1 is a perspective view illustrating a tool for processing an engine block according to the present disclosure, FIG. 2 is a schematic view briefly illustrating an axial inclination angle and a radial inclination angle of a main cutting edge according to the present disclosure, FIG. 3A is a view illustrating a tool life with respect to a cutting speed according to the present disclosure, FIG. 3B is a view illustrating surface roughness with respect to a feed per tooth according to the present disclosure, and FIG. 3C is a view illustrating a tool life with respect to a radial inclination angle of an insert according to the present disclosure.

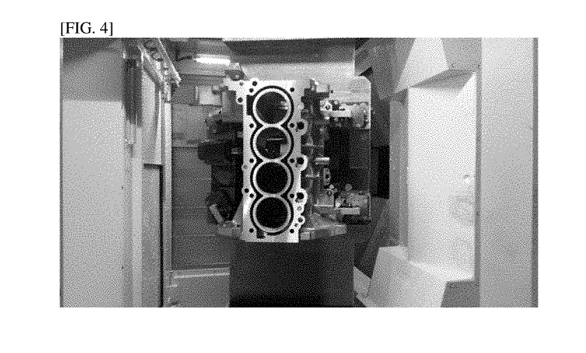

Referring to FIG. 1, a tool 100 according to the present disclosure for processing an engine block such as an engine block illustrated in FIG. 4 includes a cutter main body 110, multiple inserts 120 which are formed along an outer circumference of the cutter main body 110, and main cutting edges 130 which are provided at end portions of the inserts 120, respectively.

The insert 120 may be particularly made of a poly crystalline diamond (PCD) material which is a diamond sintered material, but the insert 120 may also be made of other materials for simultaneously processing aluminum and cast iron.

The main cutting edge 130 for facing purpose and the main cutting edge 130 for wiping purpose may be alternately formed on the inserts, respectively, but particularly, only the main cutting edge 130 for wiping purpose may be formed to improve roughness of the engine block and increase a tool life.

To process an engine block made of different materials, it is essential to provide a tool for processing an engine block which has basically a prolonged tool life in order to inhibit burrs from being formed, ensure excellent roughness, improve economic feasibility regarding the processing, and improve productivity.

According to the present disclosure, experiments have been conducted under various conditions based on a cutting speed (vc), a spindle rotational speed (n), a feed per tooth (fz), and a table feed rate (ye in order to improve the tool life.

### Example 1

Cutting speed=500 m/min

Spindle rotational speed=637 rpm

Feed per tooth=0.063 mm/tooth

Table feed rate=1,200 mm/min

### Example 2

Cutting speed=600 m/min

Spindle rotational speed=764 rpm

Feed per tooth=0.087 mm/tooth

Table feed rate=2,000 mm/min

### Comparative Example 1

Cutting speed=832 m/min

Spindle rotational speed=1,060 rpm

Feed per tooth=0.063 mm/tooth

Table feed rate=2,000 mm/min

### Comparative Example 2

Cutting speed=1,570 m/min

Spindle rotational speed=2,000 rpm

Feed per tooth=0.033 mm/tooth

Table feed rate=2,000 mm/min

Examples 1 and 2 show excellent roughness, Example 1 shows a tool life of 1,000 ea/corner, and Example 2 shows a tool life of 900 ea/corner.

However, Comparative Example 1 shows defective roughness, Comparative Example 2 shows good roughness, Comparative Example 1 shows a tool life of 400 ea/corner, and Comparative Example 2 shows a tool life of 200 ea/corner.

Referring to FIG. 3A, regarding the tool life with respect to the cutting speed, the tool life is 1,000 ea/corner when the cutting speed is 500 m/min, and the tool life shows a tendency to be inversely proportional to an increase in cutting speed.

Referring to FIG. 3B, regarding the surface roughness with respect to the feed per tooth, the best surface roughness is shown when the feed per tooth is 0.033 mm/tooth, and the surface roughness has a good value until the feed per tooth becomes 0.099 mm/tooth.

Accordingly, according to the present disclosure, the tool may process the engine block made of different materials with the cutting speed of 400 to 800 m/min, the feed per tooth of 0.05 to 0.099 mm/tooth, and the spindle rotational speed of 637 to 764 rpm.

More particularly, according to an exemplary embodiment of the present disclosure, within a range in which the surface roughness is basically satisfied and the tool life of 900 ea/corner or more is also satisfied, the cutting speed is 500 to 600 m/min, the feed per tooth is 0.062 to 0.087 mm/tooth, and the spindle rotational speed is 637 to 764 rpm.

The processing may be performed with a cutting depth of 0.03 to 0.5 mm in order to satisfy the tool life.

Referring to FIG. 2, the main cutting edge 130 is formed to have a predetermined approach angle and a predetermined cutting angle, the main cutting edge 130 has a positive axial inclination angle AR and a radial inclination angle RR of −5 degrees to 0 degree, and the axial inclination angle AR has a positive value.

Referring to FIG. 3C, the tool life was measured while changing the radial inclination angle RR under a condition in which the axial inclination angle AR is 6 degrees, the cutting speed is 500 m/min, the feed per tooth is 0.062 mm/tooth, and the spindle rotational speed is 637 rpm.

In this case, the tool life is 1,000 ea/corner when the radial inclination angle

RR is −2 degrees, and the tool life is gradually decreased when the radial inclination angle RR is increased or decreased from −2 degrees.

Accordingly, it is possible to increase the tool life when the cast iron liner and the engine block made of aluminum are simultaneously processed under the aforementioned condition, and the increase in tool life reduces production costs and innovatively increases productivity of the engine block.

It will be appreciated that the exemplary embodiments of the present disclosure have been described above for purposes of illustration, and those skilled in the art may understand that the present disclosure may be easily modified in other specific forms without changing the technical spirit or the essential features of the present disclosure. Therefore, it should be understood that the above-described exemplary embodiments are illustrative in all aspects and do not limit the present disclosure. For example, each component described as a single type may be implemented in a distributed manner. Likewise, components described as a distributed type can be implemented in a combined type.

The scope of the present disclosure is represented by the claims to be described below rather than the detailed description, and it should be interpreted that the meaning and scope of the claims and all the changes or modified forms derived from the equivalent concepts thereto fall within the scope of the present disclosure.

From the foregoing, it will be appreciated that various embodiments of the present disclosure have been described herein for purposes of illustration, and that various modifications may be made without departing from the scope and spirit of the present disclosure. Accordingly, the various embodiments disclosed herein are not intended to be limiting, with the true scope and spirit being indicated by the following claims.

What is claimed is:

1. A tool for simultaneously processing an engine block made of different materials, the tool comprising:
multiple cutting inserts; and
main cutting edges which are formed at end portions of the inserts, respectively,
wherein the main cutting edge has a positive axial inclination angle and a radial inclination angle of −5 degrees to 0 degree.

2. The tool of claim 1, wherein the tool processes the engine block made of different materials with a cutting speed of 400 to 800 m/min and a feed per tooth of 0.05 to 0.099 mm/tooth.

3. The tool of claim 2, wherein the tool processes the engine block made of different materials with a spindle rotational speed of 637 to 764 rpm.

4. The tool of claim 2, wherein the tool processes the engine block made of different materials with a cutting speed of 500 to 600 m/min and a feed per tooth of 0.062 to 0.087 m/tooth.

5. A method of processing an engine block made of different materials by using a tool including a cutting insert, wherein the tool processes the engine block made of different materials with a cutting speed of 400 to 800 m/min, a feed per tooth of 0.05 to 0.099 mm/tooth, and a spindle rotational speed of 637 to 764 rpm.
